(19) United States
(12) Patent Application Publication
(10) Pub. No.: US 2013/0036917 A1
(43) Pub. Date: Feb. 14, 2013

(54) STIR LID WITH OVERFLOW SENSOR

(71) Applicant: Marianne Berge, San Fransisco, CA (US)

(72) Inventor: Marianne Berge, San Fransisco, CA (US)

(21) Appl. No.: 13/206,451

(22) Filed: Aug. 9, 2011

(51) Int. Cl. A47J 44/02; A47J 36/00; B01F 13/04

(52) U.S. Cl. 99/344; 366/142

(57) ABSTRACT

A motor-driven automatic cooking vessel stirring device having boil-over sensing and a boil over alarm that sounds when boil-over becomes imminent. The motor-driven automatic cooking vessel stirring device beneficially also provides for temperature sensing and can include electronic controls that control stirring rates and a clock-timer.

### FIELD OF THE INVENTION

The presently disclosed subject matter is directed towards a cooking lid having a motorized stirring mechanism and an overflow sensor.

### BACKGROUND OF THE INVENTION

The preparation of many dishes requires a cook to stir a pot or other cooking vessel during preparation and/or cooking. For example, most soups, stews, chilies, sauces, and gravies must be stirred to mix ingredients, to cook evenly, and to prevent burning. Traditionally cooks manually manipulated spoons, forks, whisks, paddles and other implements to stir ingredients. While much of cooking can be enjoyable, stirring dishes can quickly become tiresome and time consuming However, stirring is often a required activity to prevent settling, burning, discoloring, and loss of flavor.

Many other time consuming and repetitive kitchen activities have been mechanized. For example, beaters, either hand driven or motorized, have become commonplace for mixing; choppers and dicers are commonly used to cut, slice and dice ingredients; and pasta makers and dough kneaders are widely used when preparing breads and other dough-based foods. While such kitchen utensils are mechanized and often motor driven they usually operate under the immediate control of a cook. This is advantageous because a cook can prevent damage to the kitchen, kitchen utensils, and dish ingredients in case of a malfunction.

While kitchen device mechanization is wide spread, stirring mechanization has been problematic. One major problem relates to the simple fact that to keep food hot when preparing a meal, heat, potentially a very dangerous quantity, must be added. With a mechanized stirrer, a chef would no longer have to attend to the rather mundane task of stirring. However, such would not relieve the chef of monitoring the kitchen for safety. For example, adding heat to a pot can easily cause a pot to boil over. At best boil-over causes a clean up situation, and at worst a serious fire or other damage.

Pot boil-over is almost always a function of temperature: the hotter the cooking the more likely and the more severe boil-over becomes. Consequently, monitoring the temperature of the ingredients in a pot or other cooking vessel would provide the chef with information related both to the degree of ingredient heating and to the likelihood of boil-over. While temperature monitoring of food is a recommended practice, it is a practice that is often neglected. This is because of the need to, and inconvenience of, carrying and using a thermometer, of cleaning the thermometer between temperature measurements, and of taking many temperature measurements. Significantly, the hotter the ingredients are the more the stirring is needed.

Therefore, an apparatus for automatically stirring cooking pots and other cooking vessels would be beneficial. Even more beneficial would be an apparatus that automatically stirs cooking vessels while also providing a boil-over alarm. Even more beneficial would be an apparatus that automatically stirs cooking vessels, that provides a boil-over alarm, and that monitors the temperature of the ingredients in the pot or other vessel being stirred. Furthermore, an automatic vessel stirrer having temperature and boil-over sensing combined with electronic controls and a clock-timer would be even more useful.

### BRIEF SUMMARY OF THE INVENTION

The principles of the present invention provide for a motor-driven cooking vessel stirring lid. According to those principles the motor-driven automatic cooking vessel stirring lid provides for boil-over sensing and sounding of an alarm when boil-over becomes imminent. Preferably, that motor-driven automatic cooking vessel stirring device also provides for temperature sensing and includes electronic controls, beneficially including adjustable stirring rates, and a clock-timer.

### BRIEF DESCRIPTION OF THE DRAWINGS

The advantages and features of the present invention will become better understood with reference to the following detailed description and claims when taken in conjunction with the accompanying drawings, in which like elements are identified with like symbols, and in which:

FIG. 1 is a cutaway view of a motor-driven automatic cooking vessel stirring device in accord with a first embodiment of the present invention;

FIG. 2 is a cutaway view of a motor-driven automatic cooking vessel stirring device in accord with a second embodiment of the present invention;

FIG. 3 is an external perspective view of a generic stir lid that is in accord with the principles of the present invention; and

FIG. 4 is a schematic depiction of an electronics assembly suitable for use in the embodiments depicted in FIGS. 1-3.

### DETAILED DESCRIPTION OF THE INVENTION

The presently disclosed subject matter will now be described more fully hereinafter with reference to the accompanying drawings in which various embodiments are shown. However, it should be understood that this invention may take many different forms and thus the present invention should not be construed as being limited to the embodiments set forth herein. In the figures like numbers refer to like elements.

The principles of the present invention provide for a motorized, automatic cooking vessel stirring device that incorporates boil-over sensing. Preferably, the motorized, automatic cooking vessel stirring device is incorporated into a lid so as to allow moving the device to different pans and cooking vessels.

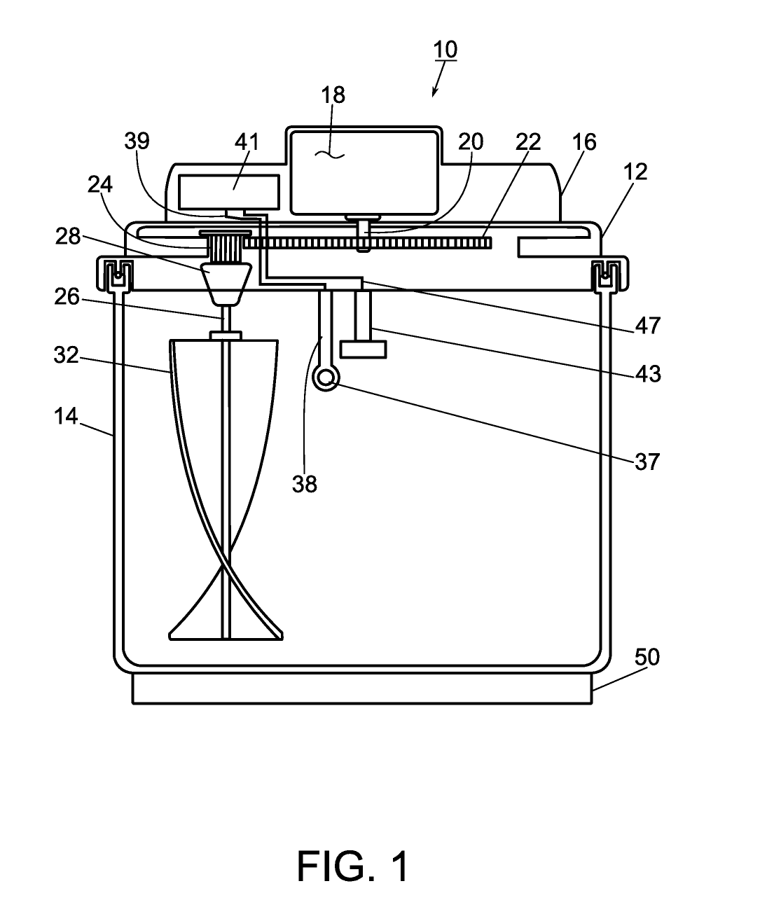

A first embodiment of the present invention is a motorized stirrer 10 as shown in FIG. 1. The motorized stirrer 10 includes a lid 12 that fits on a pot 14. While what follows refers to a lid and a pot, it should be understood that the principles of the present invention are fully applicable to other types of cooking vessels, specifically including, but not limited to, fryers, pans, slow cookers, infrared containers, and cooking dishes. Therefore, references to a pot or pots and lid or lids are for descriptive convenience and not limitation.

Still referring to FIG. 1, the lid 12 includes a case 16 that retains an electric motor 18, which is beneficially variable speed. The motor 18 includes an armature 20 that attaches to a drive gear 22. The drive gear 22 meshes with a driven gear 24 that attaches to a driven rod 26 that passes though the lid 12. The lid 12 further includes a seal bearing 28 that seals the lid hole that the driven rod 26 passes through and that provides structural support for the driven rod 26.

Still referring to FIG. 1, a stir paddle 32 attaches to the driven rod 26. As the motor 18 turns, the armature 20 turns the drive gear 22, which turns the driven gear 24. Turning the driven gear 24 causes the driven gear 24 to turn the driven rod 26 and the stir paddle 32, and to rotate around the lid 12. When the lid 12 is placed on the pot 14 this causes the stir paddle 32 to stir any ingredients in the pot 14 and to rotate around the pot 14, which provides further mixing action.

The principles of the present invention provide for sensors. FIG. 1 shows the motorized stirrer 10 as having a temperature sensor 37 that is located at or near the center of the lid 12 so as to avoid conflict with the stir paddle 32. Typical prior art temperature sensors such as thermistors, silicon temperature sensor, and resistance temperature sensors can each be used to make a temperature sensor 37. The temperature sensor 37 includes a temperature sensor lead 39 that runs up a temperature sensor 37 rod 38 to an electronics assembly 41 (described in more detail subsequently). While FIG. 1 shows the temperature sensor 37 as only having one sensor lead 39, beneficially the rod 38 and lid 12 are comprised of a thermally and electrically conductive material (such as aluminum). This allows only one sensor lead 39 to run to the electronics assembly 41 while the return is via ground.

It should be noted that the rod 38 is shown as being relatively short. However, in some applications the rod 38 will be much longer so as to extend into shallow liquid in the pot 14. Thus it should be understood that the depicted dimensions are for explanatory purposes only.

In addition to a temperature sensor 37 the motorized stirrer 10 includes a highly useful boil-over sensor 43 that senses when liquid inside the pot 14 is approaching boil-over. The boil-over sensor 43 can be a simple float-actuated switch that hangs down from the lid 12 into the pot 14 and that connects to the electronics assembly 41 by way of a boil-over sensor lead 47 (with return being ground). The position of the boil-over sensor 43 is such that it does not conflict with the stir paddle 32 or with the temperature sensor 37.

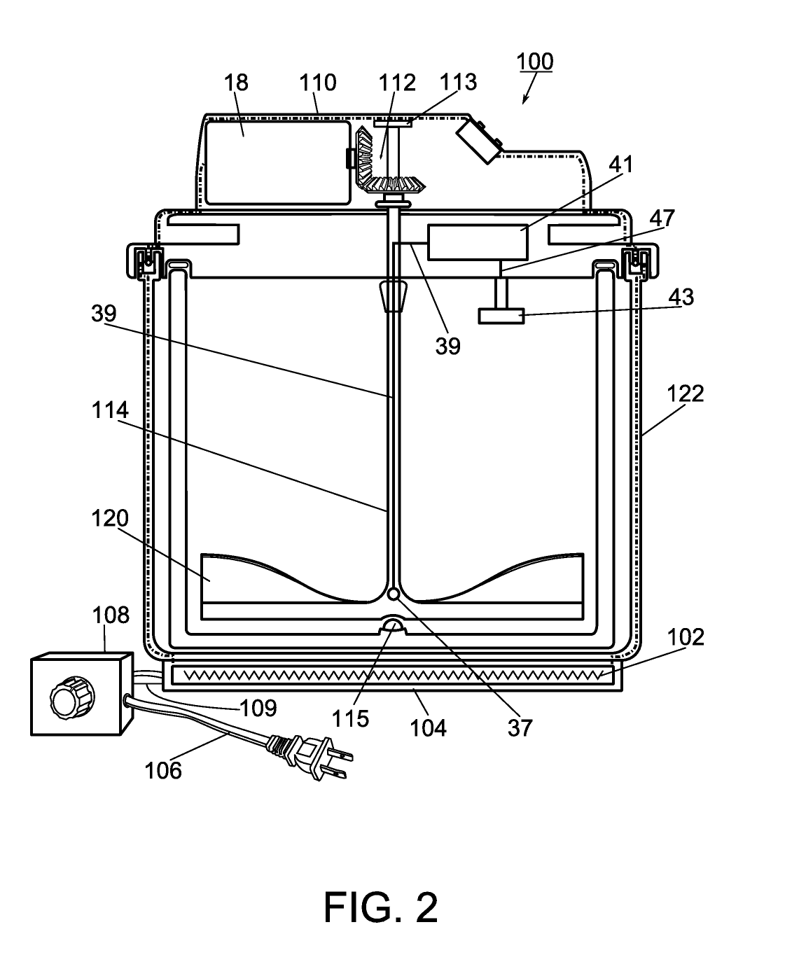

FIG. 1 illustrates the pot 14 as having a bottom 50 that is designed to sit on a burner or other heat source. However, the principles of the present invention are not limited to indirectly heated vessels. FIG. 2 illustrates a motorized stirrer 100 having an internal heat source 102 at the bottom 104 of a pot 122. The internal heat source 102 is beneficially a resistive heating element that is attached to a power cord 106 via a heat control unit 108.

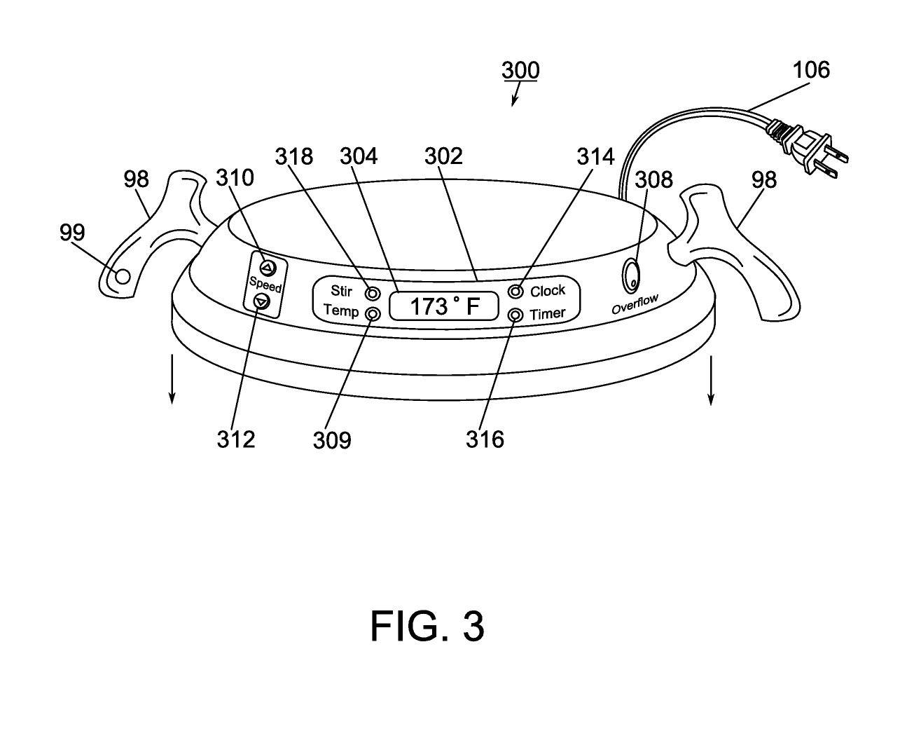

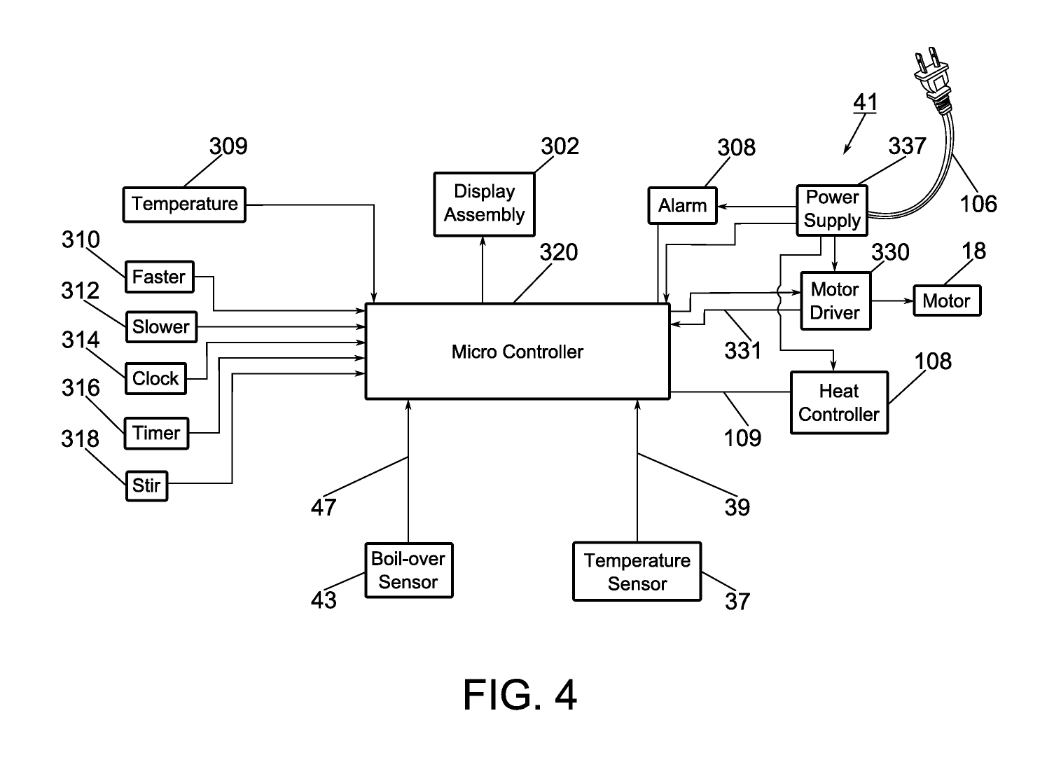

While the heat control unit 108 could be a stand alone controller, preferably the heat control unit 108 is controlled by the electronic assembly 41. In that case, the electronic assembly 41 connects to the heat control unit 108 via a heat control lead 109. Additionally, while not specifically shown in FIG. 2, but as shown in FIGS. 3 and 4, the input AC power on power line 106 can be used to input AC power to a power supply (337, see FIG. 4).

Signals from the electronic assembly 41 beneficially control a semiconductor device(s) such as a thyristor, an insulated gate transistor (IGT), a silicon controlled rectifier (SCR), another semiconductor AC switch or switch assembly, or something as simple as a relay, which is located inside the heat control unit 108. To avoid electronic switching noise and to conform to international standards the heat control unit 108 preferably implements zero voltage switching.

In addition to a different method of heating, the motorized stirrer 100 implements an alternative way of stirring. Instead of the stir paddle 32 turning around an axis created by the driven rod 26 and then rotating around a pot 14 as in the motorized stirrer 10, the motorized stirrer 100 implements a simpler stirring action. In the motorized stirrer 100 the motor 18 fits sideways inside a lid 110. The motor 18 turns a gear set 112 that converts the horizontal rotation of the motor armature into to vertical rotation. The gear set 112 turns a centralized rod 114 that attaches to and turns a paddle 120. The centralized rod 114 is supported by a bearing mount 113 at the top and by a rotatable ball 115 at the bottom. These supports prevent the paddle 120 from wobbling as it turns. As the paddle 120 turns the ingredients in the pot 122 are mixed.

The motorized stirrer 100 also includes a boil-over sensor 43, a temperature sensor 37, the electronics assembly 41, a temperature sensor lead 39, and the boil-over sensor lead 47. However, as shown, instead of the temperature sensor 37 being located in a separate rod the temperature sensor 37 is located inside the paddle 120 and its temperature sensor lead 39 runs up the centralized rod 114 to the electronics assembly 41. This requires “slip” electronic connections for the temperature sensor lead 39 and for its ground return. The motorized stirrer 100 is advantageous in that the temperature sensor 37 is located near the bottom of the pot 122, but at the cost and assembly complexity.

FIG. 3 illustrates a generic lid 300 that is helpful for illustrating various features of the lids 12 (FIGS. 1) and 110 (FIG. 2), along with some additional features, such as attachment handles 98. One or more of those handles may include an aperture 99 that could be used to hang the lid 300 from a hook. The generic lid 300 includes a display assembly 302 having a display 304. The display 304 might be an LED display, an LCD display, a plasma display, or even an analog meter. Its purpose is to provide information in a human-readable fashion to the cook. Typically displayed information might include the current time, the cooking time (a count-up time), the time to completion (a count-down timer), the temperature sensed by the temperature sensor 37, a set-operating temperature (if the electronics assembly 41 controls the operating temperature), the actual stirring speed, a stirring speed that is to be achieved, and/or an operating status (such as if a paddle is stuck). The display 304 beneficially includes indicating lights that show what information the display is currently displaying (such as a temperature LED that lights when temperature is being displayed).

Referring now to both FIGS. 3 and 4, to properly perform its functions the electronics assembly 41 requires operating input from a cook. To that end the generic lid 300 includes a temperature switch 309, a faster switch 310, a slower switch 312, a clock switch 314, a timer switch 316, and a stir switch 318. The states of those switches are input to a microcontroller 320 which processes the switch states to control the overall operation of the lid 300 (or the lids 12 or 110).

While the specific switch names and functions in practical embodiments may differ from that described herein the general principles remain the same: input information is applied to the microcontroller 320, the microcontroller 320 processes its input information in accord with a software program, and then controls the various functions in accord with the software program. However, for illustrative purposes the operation of the electronics assembly 41 in the generic lid 300 will be described in some operative detail.

Still referring to FIGS. 3 and 4, the temperature sensor 37 (FIGS. 1, 2, and 3) sends its sensed temperature to the microcontroller 320 via temperature lead 39. The microcontroller 320 processes that sensed temperature against a set-point temperature (see below). If the sensed temperature exceeds the set-point temperature, the microcontroller 320 sends an alarm signal to an alarm 308 that causes the alarm 308 to signal the cook of the existence of a problem.

The temperature set-point is set using multiple switch actions as is common in modern electronics. For example, to adjust the set-point temperature the temperature switch 309 is pressed to show that temperature is being adjusted. Then another switch is simultaneously pressed to adjust the set point temperature, such as the faster switch 310 being pressed to increase the set-point temperature or the slower switch 312 being pressed to lower the set point temperature. The set-point temperature is beneficially displayed on the display 304.

Additionally, if the display assembly 302 is set to show the temperature the microcontroller 320 processes the sensed temperature from the temperature sensor 37 and causes the display 304 to show the current temperature.

If the generic lid 300 controls the heat applied to a pot (such as the pot 122 of FIG. 2) the microcontroller 320 processes the sensed temperature from the temperature sensor 37 to determine if more heat should be applied to the pot. That is, if the temperature sensor 37 senses a temperature at or above the desired cooking temperature no additional heat is required, otherwise more heat should be applied. If more heat should be applied the microcontroller 320 sends heat control signals via a line 109 to a heat controller 108 to causes that heat controller to apply more heat to the pot.

The clock switch 314 is similarly used to adjust the clock functions of the display assembly 302. Pressing the clock switch 314 sends a signal to the microcontroller 320 that causes the microcontroller 320 to have the display 304 show the time. To advance the time both the clock switch 314 and the faster switch 310 are pressed simultaneously; to turn the clock back both the clock switch 314 and the slower switch 312 are pressed simultaneously.

The microcontroller 320 can set cooking time. Pressing the timer switch 316 sends a signal to the microcontroller 320 that causes the microcontroller 320 to have the display 304 show the cooking time. To advance the timer both the timer switch 316 and the faster switch 310 are pressed simultaneously; to turn the timer back both the timer switch 316 and the slower switch 312 are pressed simultaneously. When the timer switch 316 is released the microcontroller 320 causes the display assembly 302 to show how much cooking time remains. When the timer times down to zero the microcontroller 320 causes the alarm 308 to activate. Alternatively, pressing the timer switch 316 again will induce the microprocessor 320 to cause the display 304 to show the actual cooking time.

The microcontroller 320 can set the stirring speed. Pressing the stir switch 318 sends a signal to the microcontroller 320 that causes the microcontroller 320 to have the display assembly 302 show the stirring speed (using units such as revolutions per minute or a simple 0-10 scale, or another convenient stir speed indication). To increase the stir speed the stir switch 318 and the faster switch 310 are pressed simultaneously; to decrease the stir speed both the stir switch 318 and the slower switch 312 are pressed simultaneously.

Actually controlling the stir speed requires a motor driver 330 that accepts signals from the microcontroller 320. The motor drive 330 sends appropriate drive signals to the motor 18. One reason for the motor driver 330 is that microcontrollers 320 tend to have relatively low current drives while the motor 18 might require a much higher current. Another reason is that the motor 18 might operate on AC current, which is incompatible with direct current signals form the microcontroller 320. The motor driver 330 might also feed back the actual stirring speed via a signal line 331 to the microcontroller 320 to allow the microcontroller 320 to actually sense the stir speed.

The power to drive the motor 18, the heat controller 108, and the electronics are beneficially derived from AC line power. Such power is input on an AC power line 106 that is applied to a power supply 337. The power supply 337 converts the input AC power to the required power format(s) and applies the formatted power to the microcontroller 320, to the alarm 308, and to the motor driver 330. The microcontroller 320 then distributes power as required to the low current devices. If the heat controller 108 uses AC power the power supply 337 sends AC power to the heat controller 108. If the heat controller 108 uses DC power the power supply 337 sends the appropriate DC power to the heat controller 108

The principles of the present invention provide for boil-over sensing. As described above, to that end a boil-over sensor 43 is provided. That boil-over sensor 43 inputs a boil-over signal to the microcontroller 320 via the boil-over sensor line 47 when liquid in a pot (14 or 122) is near boil-over. That is, when liquid in the pot rises to the boil-over sensor 43, an assumption is made that boil-over is imminent. Upon receipt of the boil-over signal the microcontroller 320 causes the alarm 308 to activate.

As previously noted, the principles of the present invention can be easily adapted to fit over a wide variety of vessels. Therefore it should be clearly understood that the foregoing embodiments of the present invention are exemplary only. They are not intended to be exhaustive or to limit the invention to the precise forms disclosed, and obviously many modifications and variations are possible in light of the above teaching. Others who are skilled in the applicable arts will recognize numerous modifications and adaptations of the illustrated embodiments that remain within the principles of the present invention. Therefore, the present invention is to be limited only by the appended claims.

What is claimed:

1. A vessel stirring device, comprising:
a lid having a cavity that defines a lower surface and a top surface, said lid for fitting over a cooking vessel with said lower surface proximate the cooking vessel;
an electric motor within said cavity;
a stir paddle extending from said lower surface, said stir paddle operatively connected to and driven by said electric motor;
a boil-over sensing extending from said lower surface, said boil-over sensor for producing a boil-over signal when boil-over becomes imminent; and
a boil-over alarm operatively connected to said boil-over signal and for signaling when boil-over is imminent.

2. A cooking vessel according to claim 1, further including a gear disposed between said electric motor and said stir paddle.

3. A cooking vessel according to claim 1, wherein said electric motor is variable speed.

4. A cooking vessel according to claim 1, further including a temperature sensor for sensing the temperature of ingredients in the cooking vessel.

5. A cooking vessel according to claim 1, further including an electric heating element for heating the cooking vessel.

6. A cooking vessel stirring device, comprising:
a lid having a cavity that defines a lower surface and an exterior surface, said lid for fitting over a cooking vessel with said lower surface proximate the cooking vessel;
an electric motor within said cavity;
a stir paddle extending from said lower surface, said stir paddle operatively connected to and driven by said electric motor;
an electronics assembly within said cavity;
a boil-over sensing extending from said lower surface, said boil-over sensor for applying a boil-over signal to said electronics assembly when boil-over becomes imminent; and
a boil-over alarm operatively connected to said electronics assembly, said boil-over alarm for producing an alarm signaling when boil-over becomes imminent;
wherein said electronics assembly induces said boil-over alarm to produce said alarm signal when said boil-over signal is received.

7. A cooking vessel stirring device according to claim 6, wherein said electronics assembly includes a processor unit.

8. A cooking vessel stirring device according to claim 7, wherein said processor unit is a microcontroller.

9. A cooking vessel according to claim 6, wherein said electric motor is variable speed.

10. A cooking vessel according to claim 9, wherein said electronics assembly controls the speed of said electric motor.

11. A cooking vessel according to claim 9, further including a gear disposed between said electric motor and said stir paddle.

12. A cooking vessel according to claim 6, further including an electric heating element for heating the cooking vessel.

13. A cooking vessel stirring device, comprising:
a lid having a cavity that defines a lower surface and an exterior surface, said lid for fitting over a cooking vessel with said lower surface proximate the cooking vessel;
an electric motor within said cavity;
an electronics assembly within said cavity;
a display unit operatively connected to said electronics assembly;
a stir paddle extending from said internal surface, said stir paddle operatively connected to and driven by said electric motor;
a boil-over sensing extending from said lower surface and operatively connected to said electronics assembly, said boil-over sensor for applying a boil-over signal to said electronics assembly when boil-over becomes imminent; and
an alarm operatively connected to said electronics assembly, said alarm for producing an alarm signal when boil-over becomes imminent;
wherein said electronics assembly induces said boil-over alarm to produce said alarm signal when said boil-over signal is received; and
wherein said electronics assembly can cause said display unit to show time.

14. A cooking vessel stirring device according to claim 13, wherein said electronics assembly includes a microcontroller.

15. A cooking vessel according to claim 13, further including a temperature sensor for sensing the temperature of ingredients in the cooking vessel, wherein said temperature is operatively connected to said electronics assembly, and wherein said electronics assembly induces said display unit to show temperature.

16. A cooking vessel according to claim 15, wherein said alarm produces said alarm signal when said temperature is too high.

17. A cooking vessel according to claim 13, wherein said electric motor is variable speed.

18. A cooking vessel according to claim 17, wherein said electronics assembly controls the speed of said electric motor.

19. A cooking vessel according to claim 13, further including an electric heating element for heating the cooking vessel.

20. A cooking vessel according to claim 19, wherein said electric heating element is controlled by said electronics assembly.
